(19) United States
(12) Patent Application Publication
(10) Pub. No.: US 2002/0004829 A1
(43) Pub. Date: Jan. 10, 2002

(54) Protocol analyzer, protocol analyzing method, storage medium, data signal and computer program

(75) Inventor: Daisuke Yasunami, Ota-ku (JP)

Correspondence Address: OLIFF & BERRIDGE, PLC, P.O. BOX 19928, ALEXANDRIA, VA, 22320, US

(73) Assignee: ANDO ELECTRIC CO., LTD., Ota-ku (JP)

(21) Appl. No.: 09/863,274

(22) Filed: May 24, 2001

(30) Foreign Application Priority Data
Jun. 9, 2000 (JP) 2000-173666

(51) Int. Cl. G06F 15/173

(52) U.S. Cl. 709/224; 714/39

(57) ABSTRACT

A protocol analyzer, a protocol analyzing method, a data storage medium, a data signal and a computer program, for exactly analyzing and displaying the OBEX protocol rapidly, according to the single frame analysis. The protocol analyzer (10) comprises: a storage section (1) for storing data for every frame, therein; an extension attribute addition section (2) for reading the data for every frame, to set a notification flag in a state in a predetermined case and to add an extension attribute to the data in a predetermined case; and an analysis section (2) for analyzing and outputting the data for every frame, according to a frame format, in a predetermined case, and for deciding the frame type of the data according to the extension attribute added to the data, to analyze and output the data according to the frame format in a predetermined case.

### BACKGROUND OF THE INVENTION

Field of the Invention

The present invention relates to a protocol analyzer, a protocol analyzing method, a storage medium, a data signal and a computer program, for receiving data interactively transmitted between communication terminals through a communication line, for every frame, to analyze the data according to a format of the frame.

Description of Related Art

According to an earlier development, as a method of shooting a part of a communication line, at which a failure has occurred, a method of verifying that a communication protocol causes a failure or not, is known. According to the above-described method, when a protocol analyzer receives data transmitted through the communication line, for every frame, the protocol analyzer analyzes the data for every frame, according to the communication protocol. Thereafter, when the protocol analyzer displays the analyzed result of the data on a display unit thereof, a bit field value of each frame is decided to be normal or not, for every frame. Thereby, the protocol analyzer uses the determined result of the bit field values to cut the part of the communication line, at which the failure has occurred.

According to the frame (protocol frame) provided by the communication protocol, the format of the frame is decided for every field, in accordance with the type of the frame, as shown in FIGS. 4A and 4B.

For example, in the case of an IP frame as shown in FIG. 4A, the format of each field is fixed. Therefore, the IP frame is an invariable frame wherein the necessary status to communicate data is decided for every field.

Further, for example, in the case of a X.25 packet as shown in FIG. 4B, the X.25 packet is a variable frame wherein the format of each field from a field of a packet type is decided according to the packet type.

As a method of analyzing the protocol, a single frame analysis and a sequential analysis are known.

According to the single frame analysis, the protocol analyzer analyzes data of one single frame of frames received thereby, in order, according to the protocol, as shown in FIG. 5A. According to the sequential analysis, the protocol analyzer analyzes data of one frame of frames received thereby, by deciding the correlation between the frame and frames before and after thereof, in order, according to the protocol, as shown in FIG. 5B.

According to the single frame analysis, when the protocol analyzer receives or stores data of frames as capture data, an analysis processing unit reads in and analyzes data of one single frame of the frames, in order. Consequently, because the load of the analysis processing unit is light, it is possible that the protocol analyzer carries out the analysis of the protocol at a high speed.

According to the sequential analysis, when the analysis processing unit reads in data of the frames, the analysis processing unit analyzes data of one frame of the frames by deciding the correlation between the frame and frames before and after thereof, in order. Consequently, it is possible that the sequential analysis applies to a particular protocol wherein the format of the frame varies according to the communication sequence, such as an IrOBEX (IrDA Object Exchange Protocol; hereinafter, it calls as an OBEX). However, because the load of the analysis processing unit for deciding the communication sequence is heavy, the problem occurs that the display of the analyzed result on a display unit is late. As a result, because most of the frames has the format fixed according to the protocol, the single frame analysis of performing the simple processing is applied to the analysis of protocol.

The frame provided according to the above-described OBEX protocol is divided into some types of OBEX frames as shown in FIGS. 6A and 6B, in accordance with the opecode as shown in FIGS. 7A and 7B, added to the first field of each frame. Further, the frame has different formats according to the transmission direction thereof.

According to the direction from the client to the server, that is a T-direction shown in FIG. 8A, as shown in FIG. 6A, the above-described OBEX frame is divided into three types of T-direction frames that are an extension frame having the opecode “Connect”, a “SetPath” frame having the oprcode “SetPath”, and an ordinary frame having the opecode other than “Connect” and “SetPath”. Hereinafter, the extension frame having the opecode “Connect” will be called a “Connect” frame.

On the other hand, according to the direction from the server to the client, that is a R-direction shown in FIG. 8A, as shown in FIG. 6B, the above-described OBEX frame is divided into two types of R-direction frames that an ordinary frame and an extension frame, which have the same formats of the ordinary frame and the extension frame of the T-direction frame, respectively.

As shown in FIG. 8C, only the R-direction frame as the response to the T-direction extension frame that is the “Connect” frame is the extension frame. Further, as shown in FIG. 8D, if the “Connect” frame is transmitted in the T-direction, continuously, the R-direction frame as the response to the last “Connect” frame is the extension frame. Furthermore, as shown in FIG. 8B, in the case the frame other than the “Connect” frame is transmitted in the T-direction, the R-direction frame is the ordinary frame regardless of the opecode of the T-direction frame.

When the protocol analyzer detects the opecode of the first one-byte field of each T-direction frame, the protocol analyzer can decide that each T-direction frame is any one of the extension frame (“Connect” frame), the “SetPath” frame and the ordinary frame. However, as explained with reference to FIGS. 8A to 8D, the R-direction frame varies to the ordinary frame or the extension frame according to the communication sequence, that is, according to T-direction frame before the R-direction frame.

Therefore, as shown in FIG. 9, in accordance with the single frame analysis according to an earlier development, because the protocol analyzer decides and analyzes data for every frame, it is impossible that the protocol analyzer decide that the R-direction frame is the ordinary frame or the extension frame.

### SUMMARY OF THE INVENTION

The present invention was developed in order to solve the problems as mentioned above.

An object of the present invention is to provide a protocol analyzer, a protocol analyzing method, a data storage medium, a data signal and a computer program, for exactly analyzing and displaying the OBEX protocol rapidly, according to the single frame analysis.

In accordance with a first aspect of the present invention, according to a protocol analyzer (for example, a protocol analyzer 10 shown in FIG. 1) for receiving data interactively transmitted between communication terminals (for example, a server 20 and a client 30 shown in FIG. 1) through a communication line (for example, a communication line 40 shown in FIG. 1), for every frame, to analyze and output the data according to a format of the frame, the protocol analyzer comprises:

a storage section (for example, a RAM 1 shown in FIG. 1) for storing the data in order received through the communication line, for every frame, therein;

an extension attribute addition section (for example, a CPU 2 shown in FIG. 1) for reading the data in order stored in the storage section, for every frame, to set a notification flag (for example, an internal flag of the RAM 1 shown in FIG. 1) in a state in a case (for example, ON) wherein a transmission direction of the data is a predetermined direction (for example, a T-direction from the client 30 to the server 20 shown in FIG. 1) and a frame type of the data is a predetermined frame type (for example, an extension frame shown in FIG. 6A), and to add an extension attribute (for example, an extension attribute added to each extension attribute field of frames d4 and d9 shown in FIG. 3) to the data in a case wherein the transmission direction of the data is an opposite direction (for example, a R-direction from the server 20 to the client 30 shown in FIG. 1) to the predetermined direction and the notification flag is set in the state; and

an analysis section (for example, the CPU 2 shown in FIG. 1) for analyzing and outputting the data in order stored in the storage section, for every frame, according to the format of the frame, in a case wherein the transmission direction of the data is the predetermined direction, and for deciding the frame type of the data according as the extension attribute is added to the data or not, to analyze and output the data according to the format of the frame in a case wherein the transmission direction of the data is the opposite direction to the predetermined direction.

According to the protocol analyzer of the first aspect of the present invention, because the protocol analyzer comprises the storage section, the extension attribute addition section, and the analysis section, the extension attribute is added to the data, in the case the notification flag has been set in the state when the frame type of the before data has been the predetermined frame type. Therefore, it is possible that the protocol analyzer easily decides the frame type of the data according as the extension attribute is added to the data or not, when analyzing the data. As a result, according to the single frame analysis of analyzing data for every frame, it is possible that the protocol analyzer analyzes data by deciding the correlation between the frame and frames before and after thereof.

In accordance with a second aspect of the present invention, according to a protocol analyzing method of receiving data interactively transmitted between communication terminals through a communication line, for every frame, to analyze and output the data according to a format of the frame, the protocol analyzing method comprising the steps of:

storing the data in order received through the communication line, for every frame, in a storage section;

reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state; and

analyzing and outputting the data in order stored in the storage section, for every frame, according to the format of the frame, in a case wherein the transmission direction of the data is the predetermined direction, and deciding the frame type of the data according as the extension attribute is added to the data or not, to analyze and output the data according to the format of the frame in a case wherein the transmission direction of the data is the opposite direction to the predetermined direction.

According to the protocol analyzing method of the second aspect of the present invention, because the protocol analyzing method comprises the step of storing the data in order received, the step of adding the extension attribute to the data, and the step of analyzing the data according to the format of the frame, the extension attribute is added to the data, in the case the notification flag has been set in the state when the frame type of the before data has been the predetermined frame type. Therefore, it is possible that the frame type of the data is easily decided according as the extension attribute is added to the data or not, when the data is analyzed. As a result, according to the single frame analysis of analyzing data for every frame, it is possible to provide the protocol analyzing method of analyzing data by deciding the correlation between the frame and frames before and after thereof.

In accordance with a third aspect of the present invention, according to a storage medium having a computer-executable program recorded thereon, for receiving data interactively transmitted between communication terminals through a communication line, for every frame, to analyze and output the data according to a format of the frame, the program comprises:

a program code of storing the data in order received through the communication line, for every frame, in a storage section;

a program code of reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state; and

a program code of analyzing and outputting the data in order stored in the storage section, for every frame, according to the format of the frame, in a case wherein the transmission direction of the data is the predetermined direction, and deciding the frame type of the data according as the extension attribute is added to the data or not, to analyze and output the data according to the format of the frame in a case wherein the transmission direction of the data is the opposite direction to the predetermined direction.

According to the storage medium of the third aspect of the present invention, because the storage medium has the computer-executable program recorded thereon, the program comprising the program code of storing the data in order received, the program code of adding the extension attribute to the data, and the program code of analyzing the data according to the format of the frame, the extension attribute is added to the data, in the case the notification flag has been set in the state when the frame type of the before data has been the predetermined frame type. Therefore, it is possible that the frame type of the data is easily decided according as the extension attribute is added to the data or not, when the data is analyzed. As a result, according to the single frame analysis of analyzing data for every frame, it is possible that the function of analyzing data by deciding the correlation between the frame and frames before and after thereof is added to the single frame analysis.

In accordance with a fourth aspect of the present invention, according to a data signal transmitting a computer-executable program, the data signal comprises: a data block having a program of receiving data interactively transmitted between communication terminals through a communication line, for every frame; a data block having a program of storing the data in order received through the communication line, for every frame, in a storage section; a data block having a program of reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state; a data block having a program of analyzing and outputting the data in order stored in the storage section, for every frame, according to a format of the frame, in a case wherein the transmission direction of the data is the predetermined direction; and a data block having a program of deciding the frame type of the data according as the extension attribute is added to the data or not, to analyze and output the data according to the format of the frame in a case wherein the transmission direction of the data is the opposite direction to the predetermined direction.

In accordance with a fifth aspect of the present invention, a computer program comprises program code means for performing the steps of: receiving data interactively transmitted between communication terminals through a communication line, for every frame; storing the data in order received through the communication line, for every frame, in a storage section; reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state; analyzing and outputting the data in order stored in the storage section, for every frame, according to a format of the frame, in a case wherein the transmission direction of the data is the predetermined direction; and deciding the frame type of the data according as the extension attribute is added to the data or not, to analyze and output the data according to the format of the frame in a case wherein the transmission direction of the data is the opposite direction to the predetermined direction.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a block diagram showing an internal structure of a protocol analyzer 10 according to an embodiment of present invention;

FIG. 2 is a flowchart showing a processing of adding an extension attribute according to a single frame analysis processing;

FIG. 3 is a view for explaining the single frame analysis processing according to the embodiment of the present invention;

FIG. 4A is a diagram showing a format of an IP frame, and FIG. 4B is a diagram showing a format of a X.25 packet;

FIG. 5A is a view for explaining a single frame analysis, and FIG. 5B is a view for explaining a sequential analysis;

FIG. 6A is a diagram showing formats of T-direction frames provided by an OBEX protocol, and FIG. 6B is a diagram showing formats of R-direction frames provided by the OBEX protocol;

FIG. 7A is a table of opecodes for the T-direction frame, and FIG. 7B is a table of opecodes for the R-direction frame;

FIG. 8A is a view for explaining a transmission direction between a client and a server, FIG. 8B is a view showing an exemplary R-direction frame in the case the T-direction frame is an ordinary frame, and FIGS. 8C and 8D are views showing exemplary R-direction frames in the case the T-direction frames are extension frames; and

FIG. 9 is a view for showing a single frame analysis processing according to an earlier development.

### PREFERRED EMBODIMENT OF THE INVENTION

Hereinafter, an embodiment of the present invention will be explained with reference to figures, in detail.

First, a structure of a protocol analyzer 10 according to an embodiment of the protocol analyzer of the present invention will be explained, as follows.

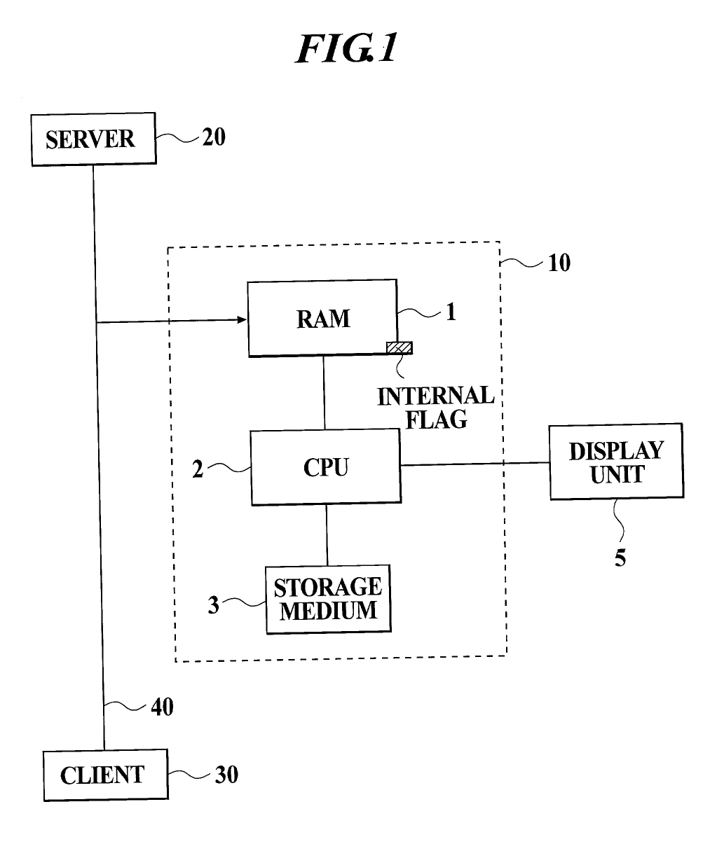

FIG. 1 is a block diagram showing an internal structure of the protocol analyzer 10.

As shown in FIG. 1, the protocol analyzer 10 comprises a RAM 1, a CPU 2 and a storage medium 3. When the protocol analyzer 10 receives the R-direction frame after having received the “Connect” frame of the T-direction frame, through a communication line 40 connecting a server 20 and a client 30, the protocol analyzer 10 adds an extension attribute expressing the R-direction extension frame, to data of the R-direction frame. Thereafter, when the protocol analyzer 10 analyzes the data to which the extension attribute is added, of the R-direction frame, the protocol analyzer 10 displays the analyzed result on a display unit 5.

According to the protocol analyzer 10, when the RAM 1 receives data through the communication line 40 connecting the server 20 and the client 30, for every frame, the RAM 1 adds the extension attribute field storing the extension attribute, to each frame. Thereafter, the RAM 1 stores data of each frame including the extension attribute field, as capture data, therein. Further, the RAM 1 comprises an internal flag for indicating that the R-direction frame next to the T-direction extension frame is the extension frame.

The CPU 2 performs an attribute additional processing of adding the extension attribute to the extension attribute field of the R-direction extension frame and a single frame analysis processing, to the capture data stored in the RAM 1, according to an attribute additional processing program and an analysis processing program stored in the storage medium 3 such as a HD, a ROM or the like.

Next, a processing by the protocol analyzer 10 will be explained, as follows.

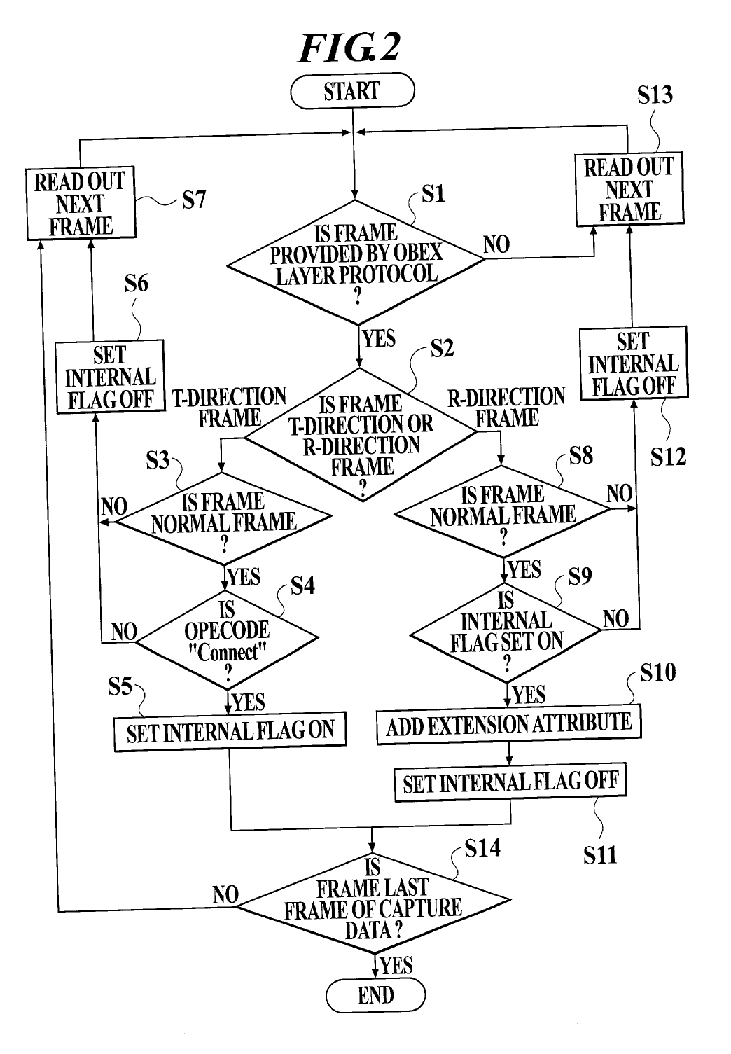

FIG. 2 is a flowchart for explaining the attribute additional processing by the protocol analyzer 10 according to the embodiment of the present invention.

The attribute additional processing is applied only to each frame provided by the OBEX layer protocol. Therefore, because the protocol analyzer 10 does not perform the attribute additional processing to the frame not provided by the OBEX layer protocol, the protocol analyzer 10 decides whether the next frame is provided by the OBEX layer protocol or not.

First, according to the protocol analyzer 10, the CPU 2 sets the internal flag of the RAM 1 OFF as an initial value. When the CPU 2 decides that the T-direction frame is the extension frame, the CPU 2 sets the internal flag of the RAM 1 ON. Accordingly, the CPU 2 can decide that the R-direction frame just after deciding the T-direction frame to be the extension frame is the extension frame, on the basis of the internal flag set ON.

Thereafter, when the CPU 2 reads data out of the capture data stored in the RAM 1, for every frame in order received by the RAM 1, the CPU 2 carries out the following attribute additional processing to the data for every frame.

The CPU 2 decides whether the frame read out of the capture data is provided by the OBEX layer protocol or not (Step S1).

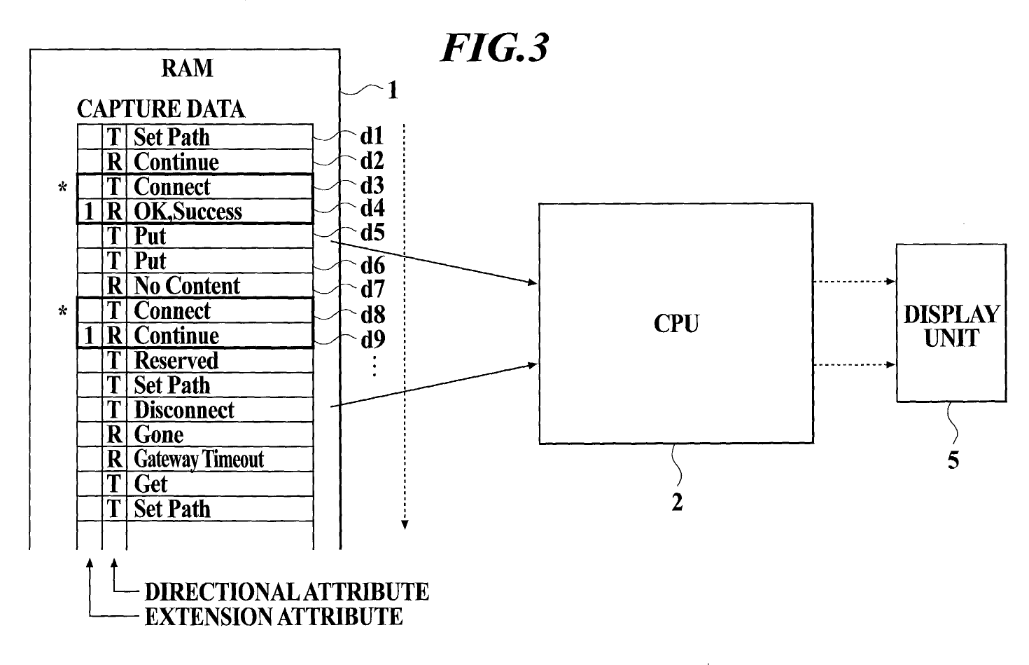

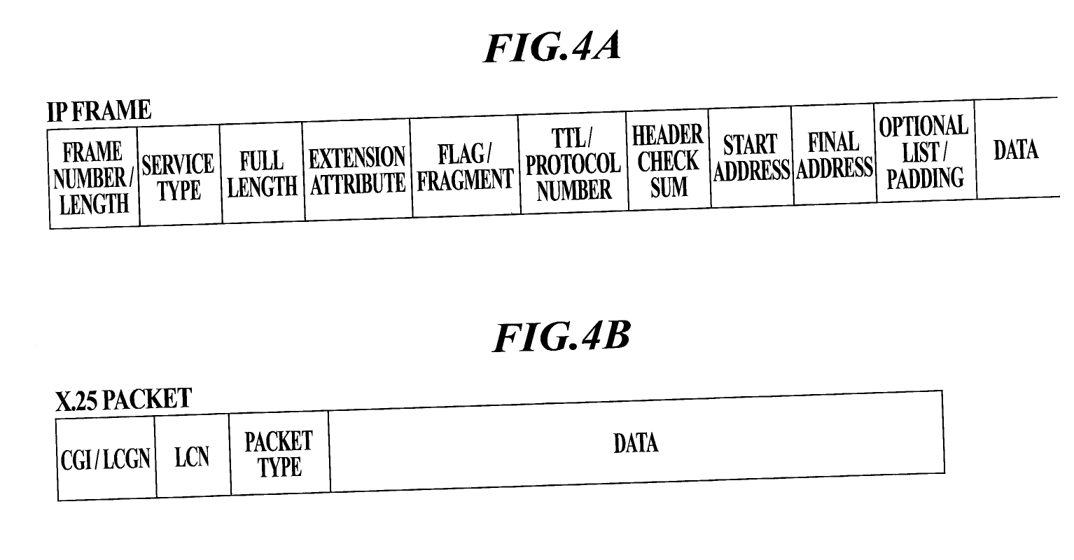

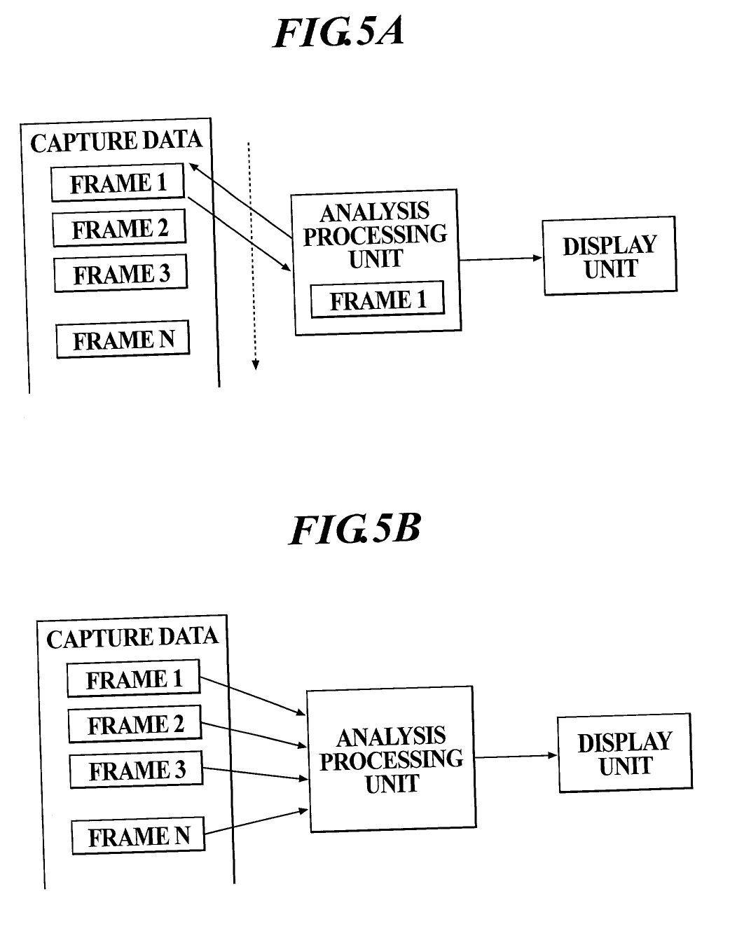

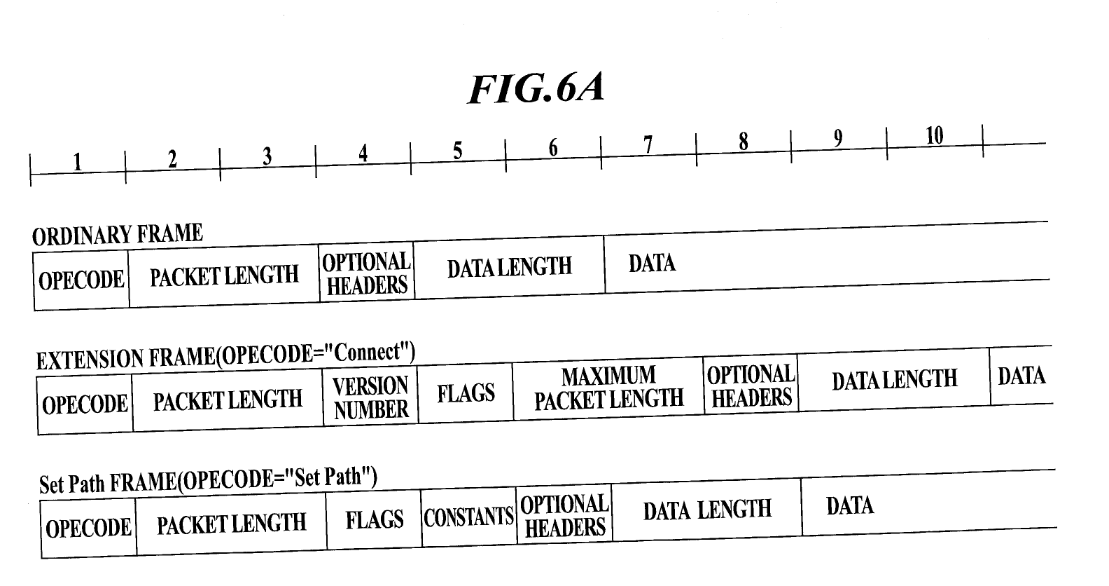

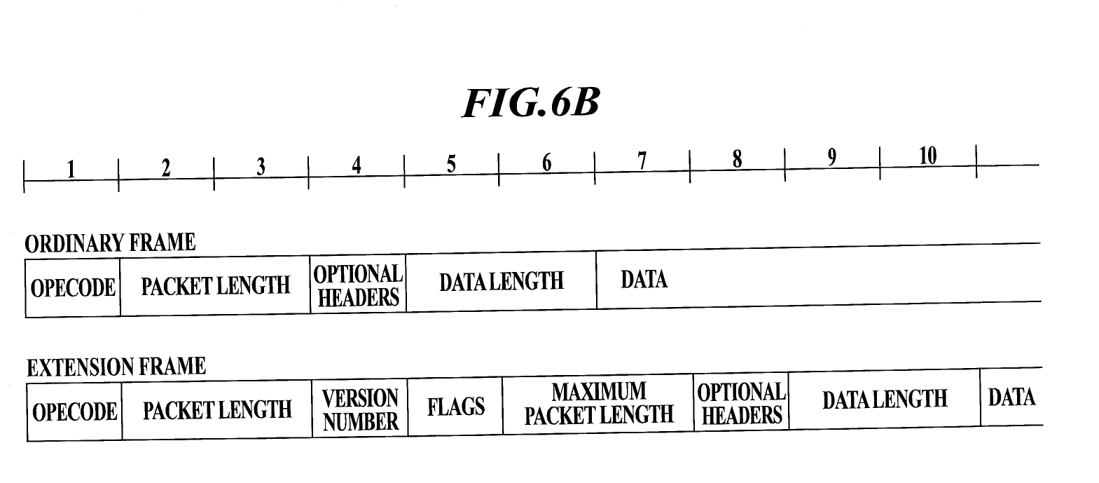

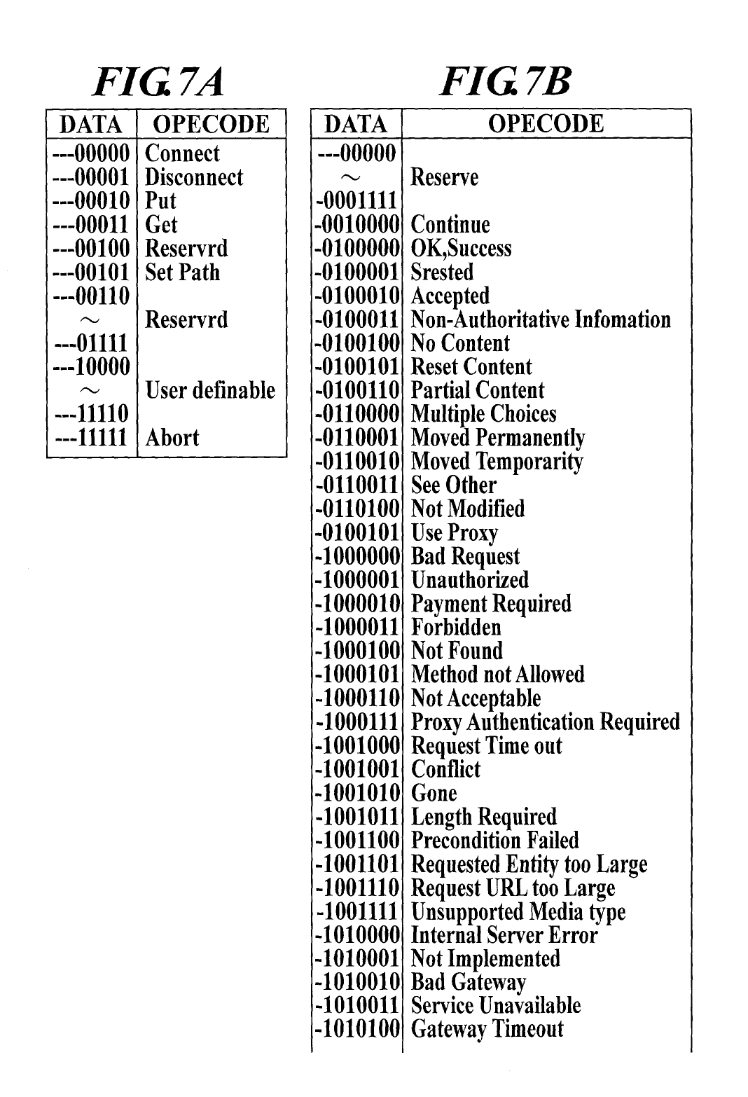

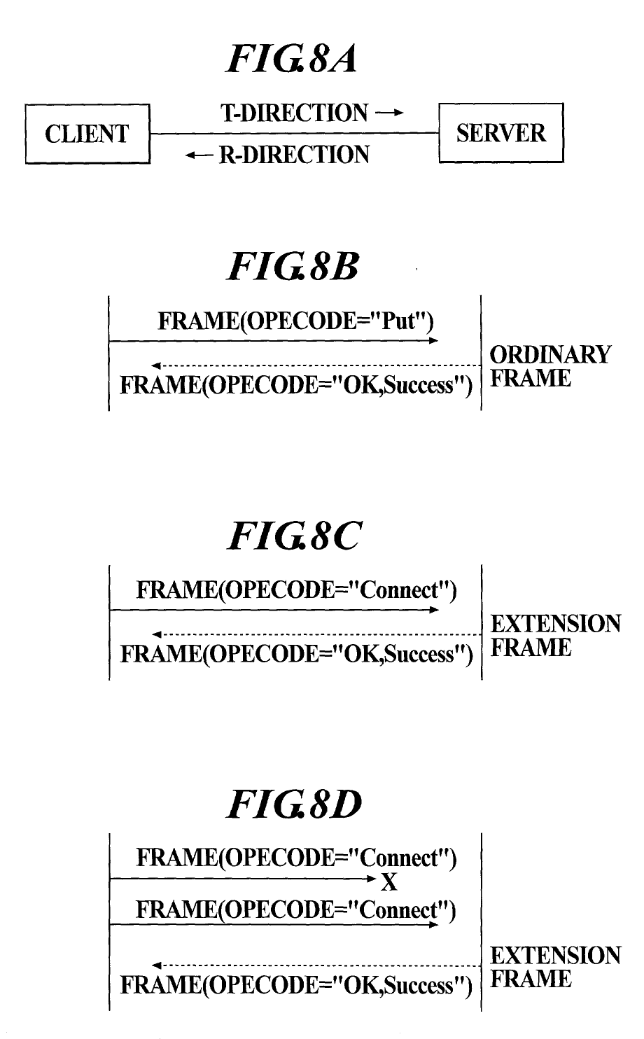

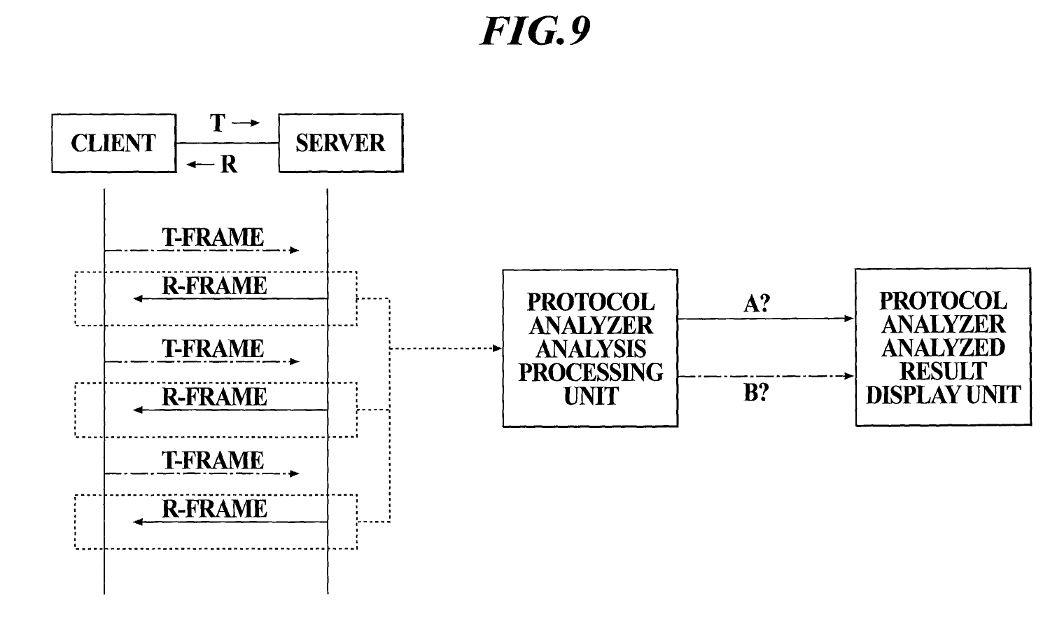

When the CPU 2 decides that the frame is not provided by the OBEX layer protocol (Step S1; NO), the CPU 2 reads the next frame out of the capture data, to decide whether the next frame is provided by the OBEX layer protocol or not (Step S13). On the other hand, when the CPU 2 decides that the frame is provided by the OBEX layer protocol (Step S1; YES), the CPU 2 decides whether the frame is the T-direction or R-direction frame, on the basis of the value of the directional attribute field of the frame, as shown in FIG. 3 (Step S2).

When the CPU 2 decides that the frame is the T-direction frame (Step S2; T-direction frame), the CPU 2 decides whether the frame is the normal frame or not (Step S3).

When the CPU 2 decides that the frame is the normal frame (Step S3; YES), the CPU 2 decides whether the opecode of the frame is the “Connect” or not (Step S4). When the CPU 2 decides that the opecode of the frame is the “Connect” (Step S4; YES), the CPU 2 sets the internal flag of the RAM 1 ON (Step S5).

Then, the CPU 2 decides whether the frame is the last one of the capture data or not (Step S14). When the CPU 2 decides that the frame is the last one of the capture data (Step S14; YES), the CPU 2 ends the attribute additional processing. On the other hand, the CPU 2 decides that the frame is not the last one of the capture data (Step S14; NO), the CPU 2 reads the next frame out of the capture data, to perform the above-described processing to the next frame (Step S7).

At the Step S3, when the CPU 2 decides that the frame is not the normal frame (Step S3; NO), or at the Step S4, when the CPU 2 decides that the opecode of the frame is not the “Connect” (Step S4; NO), the CPU 2 sets the internal flag of the RAM 1 OFF (Step S6). Then, the CPU 2 reads the next frame out of the capture data, to perform the above-described processing to the next frame (Step S7).

At the Step S2, when the CPU 2 decides that the frame is the R-direction frame (Step S2; R-direction frame), the CPU 2 decides whether the frame is the normal frame or not (Step S8).

When the CPU 2 decides that the frame is the normal frame (Step S8; YES), the CPU 2 decides whether the internal flag of the RAM 1 is set ON or not (Step S9). When the CPU 2 decides that the internal flag is set ON (Step S9; YES), because the CPU 2 decides that the frame is the R-direction extension frame, the CPU 2 adds the extension attribute to mark with “1” in the extension attribute field of the frame, as shown in FIG. 3 (Step S10). Then, when the CPU 2 sets the internal flag of the RAM 1 OFF (Step S11), the CPU 2 decides whether the frame is the last one of the capture data or not (Step S14).

When the CPU 2 decides that the frame is the last one of the capture data (Step S14; YES), the CPU 2 ends the attribute additional processing. On the other hand, the CPU 2 decides that the frame is the last one of the capture data (Step S14; NO), the CPU 2 reads the next frame out of the capture data, to perform the above-described processing to the next frame (Step S7).

At the Step S8, when the CPU 2 decides that the frame is not the normal frame (Step S8; NO), or at the Step S9, when the CPU 2 decides that the internal flag of the RAM 1 is not set ON (Step S9; NO), the CPU 2 sets the internal flag of the RAM 1 OFF (Step S12). Then, the CPU 2 reads the next frame out of the capture data, to perform the above-described processing to the next frame (Step S13).

As described above, the CPU 2 has performed the above-described processing to all frame of the capture data stored in the RAM 1 (Step S14; YES), the CPU 2 ends the present attribute additional processing.

As shown in FIG. 3, when the CPU 2 carries out the above-described attribute additional processing to all frame of the capture data stored in the RAM 1, for every frame, in order, the CPU 2 decides that the R-direction frames d4 and d9 next to the T-direction extension frames d3 and d8 are extension frames. Thereby, the CPU 2 adds the extension attribute to mark with “1” in the extension attribute field of each of the R-direction frames d4 and d9. Therefore, the CPU 2 decides whether the extension attribute is added to the extension attribute field of each R-direction frame or not, and thereby, the CPU 2 can decide whether each R-direction frame is the extension frame or the ordinary frame, easily. Accordingly, it is possible that the protocol analyzer 10 exactly analyzes each frame.

Although the present invention has been explained according to the above-described embodiment, it should also be understood that the present invention is not limited to the embodiment and various chanted and modifications may be made to the invention without departing from the gist thereof.

For example, the present attribute additional processing is performed to the capture data received and stored in the RAM 1 according to the embodiment. However, the attribute additional processing may be performed to the frame, to decide whether to add the extension attribute to the frame or not, every when the frame is received to the RAM 1. Thereby, frames including the frame to which the extension attribute is added may be stored in the RAM 1, as the capture data.

According to the capture data performed by the above-described attribute additional processing, when the type of the T-direction frame is determined on the basis of the type of the opecode, the T-direction frame is analyzed in compliance with the format of the frame type determined above, like the case according to an earlier development. Further, when the R-direction frame is determined to be the extension frame or the ordinary frame according as the extension attribute field is marked with “1” or not, the R-direction frame is analyzed in compliance with the format of the frame type determined above. As a result, according to the single frame processing, it is possible that data of the frame provided by the OBEX layer protocol, necessary to be preformed according to the sequential processing is easily analyzed and displayed rapidly.

According to the present invention, a main effect will be indicated, as follows.

According to the above-described present invention, the extension attribute is added to the data, in the case the notification flag has been set in the state when the frame type of the before data has been the predetermined frame type. Therefore, it is possible that the frame type of the data is easily decided according as the extension attribute is added to the data or not, when the data is analyzed. As a result, according to the single frame analysis of analyzing data for every frame, it is possible that data is analyzed by deciding the correlation between the frame and frames before and after thereof.

For example, according to the OBEX protocol, the T-direction frame just before the R-direction frame can be decided to be the extension frame or not according as the notification flag, that is the internal flag is set ON or OFF. Thereby, the extension attribute indicating that the frame is the extension frame can be added to the R-direction frame next to the T-direction extension frame. Therefore, when data of the R-direction frame is analyzed according to the protocol, the R-direction frame can be easily decided to be the extension frame or the ordinary frame according as the extension attribute is added to the R-direction frame or not. As a result, it is possible that data of each frame provided by the OBEX protocol is exactly analyzed and displayed rapidly, according to the single frame analysis.

The entire disclosure of Japanese Patent Application No. Tokugan 2000-173666 filed on Jun. 9, 2000 including specification, claims, drawings and summary are incorporated herein by reference in its entirety.

What is claimed is:

1. A protocol analyzer for receiving data interactively transmitted between communication terminals through a communication line, for every frame, to analyze and output the data according to a format of the frame, the protocol analyzer comprising:
a storage section for storing the data in order received through the communication line, for every frame, therein;
an extension attribute addition section for reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state; and
an analysis section for analyzing and outputting the data in order stored in the storage section, for every frame, according to the format of the frame, in a case wherein the transmission direction of the data is the predetermined direction, and for deciding the frame type of the data according as the extension attribute is added to the data or not, to analyze and output the data according to the format of the frame in a case wherein the transmission direction of the data is the opposite direction to the predetermined direction.

2. A protocol analyzing method of receiving data interactively transmitted between communication terminals through a communication line, for every frame, to analyze and output the data according to a format of the frame, the protocol analyzing method comprising the steps of:
storing the data in order received through the communication line, for every frame, in a storage section;
reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state; and
analyzing and outputting the data in order stored in the storage section, for every frame, according to the format of the frame, in a case wherein the transmission direction of the data is the predetermined direction, and deciding the frame type of the data according as the extension attribute is added to the data or not, to analyze and output the data according to the format of the frame in a case wherein the transmission direction of the data is the opposite direction to the predetermined direction.

3. A storage medium having a computer-executable program recorded thereon, for receiving data interactively transmitted between communication terminals through a communication line, for every frame, to analyze and output the data according to a format of the frame, wherein the program comprises:
a program code of storing the data in order received through the communication line, for every frame, in a storage section;
a program code of reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state; and
a program code of analyzing and outputting the data in order stored in the storage section, for every frame, according to the format of the frame, in a case wherein the transmission direction of the data is the predetermined direction, and deciding the frame type of the data according as the extension attribute is added to the data or not, to analyze and output the data according to the format of the frame in a case wherein the transmission direction of the data is the opposite direction to the predetermined direction.

4. A data signal transmitting a computer-executable program, wherein the data signal comprises:
a data block having a program of receiving data interactively transmitted between communication terminals through a communication line, for every frame;
a data block having a program of storing the data in order received through the communication line, for every frame, in a storage section;
a data block having a program of reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state;
a data block having a program of analyzing and outputting the data in order stored in the storage section, for every frame, according to a format of the frame, in a case wherein the transmission direction of the data is the predetermined direction; and
a data block having a program of deciding the frame type of the data according as the extension attribute is added to the data or not, to analyze and output the data according to the format of the frame in a case wherein the transmission direction of the data is the opposite direction to the predetermined direction.

5. A computer program comprising program code means for performing the steps of:
receiving data interactively transmitted between communication terminals through a communication line, for every frame;
storing the data in order received through the communication line, for every frame, in a storage section;
reading the data in order stored in the storage section, for every frame, to set a notification flag in a state in a case wherein a transmission direction of the data is a predetermined direction and a frame type of the data is a predetermined frame type, and to add an extension attribute to the data in a case wherein the transmission direction of the data is an opposite direction to the predetermined direction and the notification flag is set in the state;
analyzing and outputting the data in order stored in the storage section, for every frame, according to a format of the frame, in a case wherein the transmission direction of the data is the predetermined direction; and
deciding the frame type of the data according as the extension attribute is added to the data or not, to analyze and output the data according to the format of the frame in a case wherein the transmission direction of the data is the opposite direction to the predetermined direction.
